(19) United States
(12) Patent Application Publication
(10) Pub. No.: US 2012/0069424 A1
(43) Pub. Date: Mar. 22, 2012

(54) ELECTRONIC PAPER DISPLAY DEVICE

(75) Inventors: Young Woo Lee, Gyeonggi-do (KR); Hwan Soo Lee, Gyeonggi-do (KR); Sang Moon Lee, Seoul (KR)

(73) Assignee: SAMSUNG ELECTRO-MECHANICS CO., LTD.

(21) Appl. No.: 13/023,999

(22) Filed: Feb. 9, 2011

(30) Foreign Application Priority Data
Sep. 20, 2010 (KR) 10-2010-0092574

(51) Int. Cl. G02B 26/00

(52) U.S. Cl. 359/296

(57) ABSTRACT

Disclosed herein is an electronic paper display device, including: a barrier rib structure having a plurality of partitioning spaces arranged in a matrix form; and a plurality of rotating balls each disposed within the partitioning spaces in a form in which a first hemisphere and a second hemisphere are coupled, wherein the rotating ball is rotated in a preset direction by a shape of the partitioning space. Herein, the electrocic paper display device forms a cavity in an asymmetrical shape to induce the rotating ball to be rotated in one direction, thereby making it possible to easily control the rotating ball.

### CROSS REFERENCE(S) TO RELATED APPLICATIONS

This application claims the benefit under 35 U.S.C. Section [120, 119, 119(e)] of Korean Patent Application Serial No. 10-2010-0092574, entitled “Electronic Paper Display Device” filed on Sep. 20, 2010, which is hereby incorporated by reference in its entirety into this application.

### BACKGROUND OF THE INVENTION

1. Technical Field

The present invention relates to an electronic paper display device, and more particularly, to an electronic paper display device capable of easily implementing colors of an image by controlling the direction of rotating balls in a predetermined direction.

2. Description of the Related Art

Among next generation display devices, an electronic paper display device has availability and flexibility larger than those of other display devices and is able to be driven with low power. Therefore, the electronic paper display device can replace paper printing media such as books and can be applied to various kinds of screens and electronic wallpapers, etc.

As a typical color electronic paper display device, there is an electronic paper display device using rotating balls formed of hemispheres having different colors. A twist ball type electronic paper display device includes a plurality of rotating balls, a barrier rib structure providing partitioning spaces for disposing the rotating balls, an electrode structure rotating the rotating balls, and a transparent insulating oil providing lubrication to the rotating balls, etc. Herein, the partitioning spaces in which the rotating balls are disposed are referred to as a cavity.

The rotating ball has a spherical shape in which a black hemisphere and a white hemisphere are coupled to each other, and is rotated within the cavity by an electric field. At this time, black and white are displayed according to the color of the hemisphere facing a display surface of the display device.

However, since the rotating ball may be rotated in any direction within the cavity by the electric field, it is difficult to expect the rotating direction thereof. Therefore, it is difficult to control the rotating movement of the rotating ball.

### SUMMARY OF THE INVENTION

An object of the present invention is to provide a means capable of inducting a rotating ball to be rotated in one direction.

Another object of the present invention is to provide a means capable of constantly maintain a position of a rotating ball within a cavity.

According to an exemplary embodiment of the present invention, there is provided an electronic paper display device, including: a barrier rib structure providing a plurality of partitioning spaces; and a plurality of rotating balls each disposed within the partitioning spaces in a form in which a first hemisphere and a second hemisphere are coupled and rotated by an electric field applied to the barrier rib structure, wherein the rotating ball is rotated in a preset direction by a shape of the partitioning space.

A width in a first direction and a width in a second direction of the partitioning space may be different from each other, the second direction being perpendicular to the first direction.

A friction force between the rotating ball and the inner surface of the partitioning space may be larger in the first direction than in the second direction.

The width in a second direction of the partitioning space may be larger than the width in a first direction thereof.

The ratio of the width in a first direction and the width in a second direction of the partitioning space may be adjusted to be 0.6 or more to 0.9 or less.

The width in a first direction and the width in a second direction of the partitioning space may be equal to or larger than a diameter of the rolling ball.

The first direction of the partitioning space may be a direction of a coupled surface of the first and second hemispheres, and the second direction thereof may be a direction perpendicular to the coupled surface of the first and second hemispheres.

A lower surface of the partitioning space may be inclined toward a center thereof.

The lower surface of the partitioning space may be a curved shape or a polygonal shape.

The first and second hemispheres may have different colors.

According to another exemplary embodiment of the present invention, there is provided an electronic paper display device, including: a barrier rib structure providing a plurality of partitioning spaces partitioned by barrier ribs; and a plurality of rotating balls formed by coupling a first hemisphere to a second hemisphere, provided in each of the partitioning spaces and rotated by an electric field applied to the barrier rib structure, wherein an interval between the rotating ball and the inner surface of the partitioning space is larger in a second direction than in a first direction.

A width in a first direction and a width in a second direction of the partitioning space may be different from each other.

The ratio of the width in a first direction and the width in a second direction of the partitioning space may be 0.6 or more to 0.9 or less.

The width in a first direction and the width in a second direction of the partitioning space may be equal to or larger than a diameter of the rolling ball.

The first direction may be a direction of a coupled surface of the first and second hemispheres, and the second direction may be a direction perpendicular to the coupled surface of the first and second hemispheres.

A lower surface of the partitioning space may be inclined toward a center thereof.

The lower surface of the partitioning space may have a curved shape or a polygonal shape.

The first and second hemispheres may have different colors.

### BRIEF DESCRIPTION OF THE DRAWINGS

FIG. 1 is a plan view showing an electronic paper display device according to an exemplary embodiment of the present invention;

FIG. 2 is an enlarged view of a portion of FIG. 1;

FIG. 3 is a cross-sectional view taken along line I-I′ of FIG. 1;

FIG. 4 is a cross-sectional view taken along line II-II′ of FIG. 1; and

FIG. 5 is an enlarged view of one of the cavities of FIG. 3.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the specification denote like elements.

Terms used in the present specification are for explaining the embodiments rather than limiting the present invention. Unless explicitly described to the contrary, a singular form includes a plural form in the present specification. The word “comprise” and/or “comprising used in the specification” will be understood to imply the inclusion of stated constituents, steps, operations and/or elements but not the exclusion of any other constituents, steps, operations and/or elements.

Hereinafter, an electronic paper display device according to exemplary embodiments of the present invention will be described with reference to the accompanying drawings.

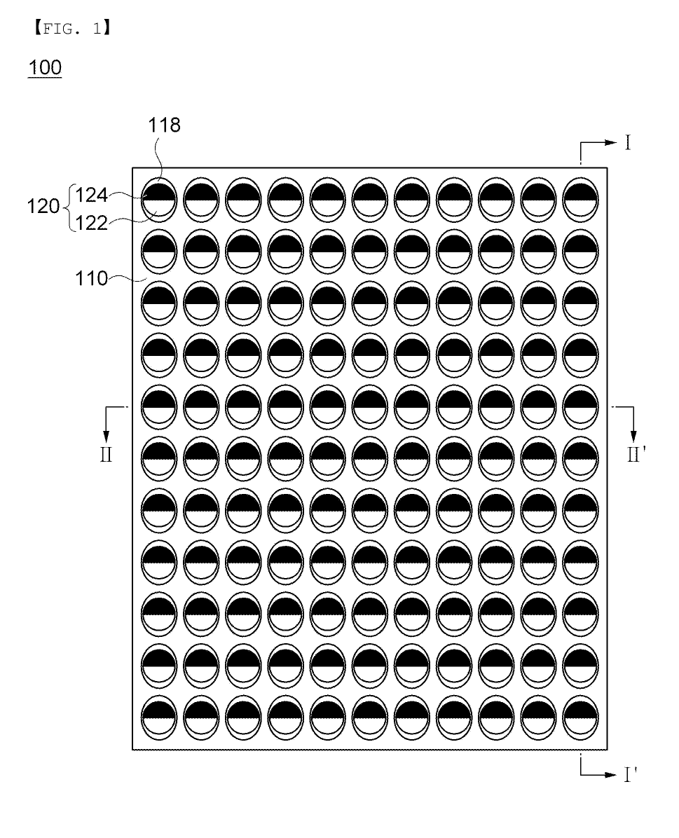

FIG. 1 is a plan view showing an electronic paper display device according to an exemplary embodiment of the present invention. Referring to FIG. 1, an electronic paper display device 100 according to an exemplary embodiment of the present invention may include a barrier rib structure 110, a plurality of cavities 118 and a plurality of rotating balls 120.

The barrier rib structure 110 may be provided with a plurality of cavities 118 arranged in a matrix form, and the rotating ball 120 may be provided in each of the cavities 118. More specifically, the barrier rib structure 110 may include a plurality of partitioning spaces partitioned by the barrier ribs, which may be defined as a cavity 118. The rotating balls 120 are provided with in each of the cavities 118 and are rotated by an electric field applied to the barrier rib structure 110.

Each of the rotating balls 122 may have a substantially spherical shape in which first and second hemispheres 122 and 124 electrified with different charges are coupled to each other. Herein, the first and second hemispheres 122 and 124 may have different colors. As an example, the first hemisphere 122 is set to white and the second hemisphere 124 is set to black, thereby making it possible to implement the electronic paper display device 100 as a monochrome scheme. As another example, the first hemisphere 122 is set to any one of blue, yellow and green and the second hemisphere 124 is set to black or white, thereby making it possible to implement the electronic paper display device 100 as a color scheme. In addition, the colors of the first hemisphere 122 and the second hemisphere 124 configuring the rotating ball 120 may variously changed and combined.

As such, since the colors of the first hemisphere 122 and the second hemisphere 124 configuring each of the rotating balls 120 are differently set, the colors displayed on a front surface of the barrier rib structure 110 become different according the rotation of the rotating balls 120. Accordingly, the electronic paper display device 100 implements a desired image by combining the colors of the rotating balls 120.

Meanwhile, an upper portion of the barrier rib structure 110 may be provided with an upper electrode and a lower portion thereof may be provided with a base substrate and a lower electrode. However, for convenience of explanation, only the barrier rib structure 110 is shown in FIG. 1.

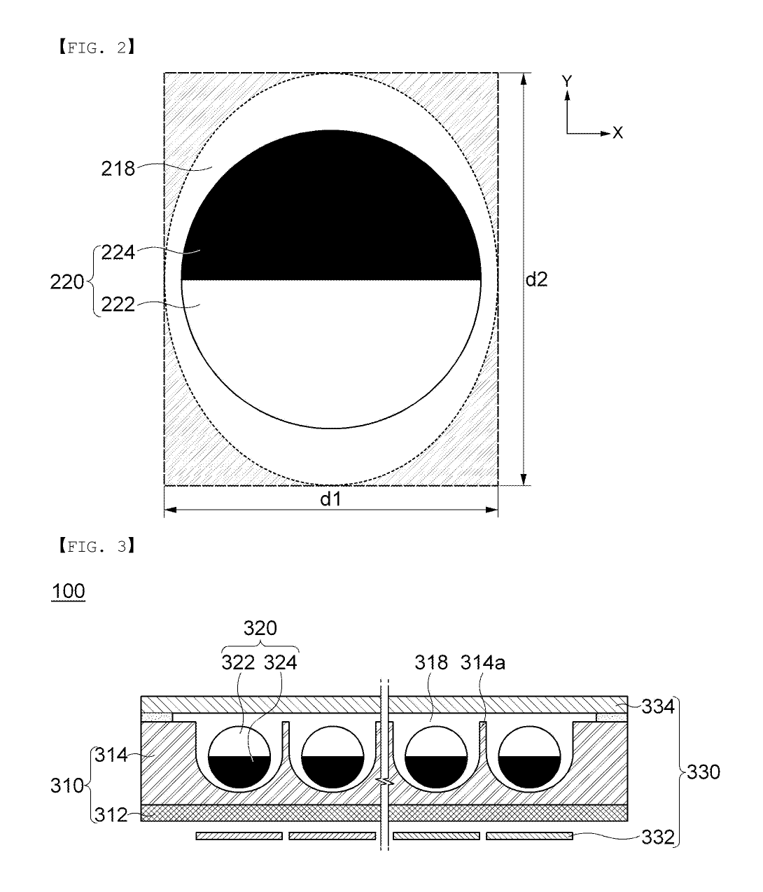

FIG. 2 is an enlarged view of a portion of FIG. 1. A cavity 218 partitioned by barrier ribs and a rotating ball 220 provided in the cavity 218 and rotated by an electric filed to implement a predetermined color are shown in FIG. 2. Herein, the rotating ball 220 may have a shape in which a first white hemisphere 222 and a second black hemisphere 224 are coupled to each other.

Meanwhile, a width (d1) in an X direction and a width (d2) in a Y direction of the cavity 218 may be formed in a predetermined ratio in proportion to a diameter of the rolling ball 220. Each of the width (d1) in an X direction and the width (d2) in a Y direction of the cavity 218 may be equal to or larger than a diameter of the rolling ball 220. In addition, the width (d1) in an X direction of the cavity 218 may be smaller than the width (d2) in a Y direction thereof. Herein, the ratio of the width (d1) in an X direction of the cavity 218 to the width (d2) in a Y direction thereof may be set to be smaller than 1, and preferably, 0.6 or more to 0.9 or less. Herein, the X direction may be a direction of a coupled surface of the first hemisphere 222 and the second hemisphere 224, and the Y direction may be a direction substantially perpendicular to the coupled surface of the first hemisphere 222 and the second hemisphere 224.

As described above, when the width (d1) in an X direction of the cavity 218 and the width (d2) in a Y direction thereof are different from each other, a friction force between the rotating ball 220 and the inner surface of the cavity 218 becomes different. For example, the friction force between the rotating ball 220 and the inner surface of the cavity 218 may be larger when the rotating ball 220 is rotated in the X direction than when the rotating ball 220 is rotated in the Y direction. The reason is that an interval between the rotating ball 220 and the inner surface of the cavity 218 is narrower in the X direction than in the Y direction. In this case, the rotating ball 220 is induced to be rotated in the Y direction having a small friction force, and the rotation in a direction different from the Y direction may be limited.

When the rotating ball 220 is induced to be rotated in a direction different from the Y direction, although the rotating ball 220 is controlled to be rotated at any angle, a portion of the white and a portion of the black are always simultaneously displayed. In this case, it is difficult to implement the color of the image due to the combination of the white and the black. However, according to the present invention, when the rotating ball 220 is rotated in the Y direction, that is, in the direction perpendicular to the coupled surface of the first hemisphere 222 and the second hemisphere 224, only one of the first hemisphere 222 and the second hemisphere 224 selectively go upwardly, thereby making it possible to selectively implement the black and the white. Accordingly, the rotating ball 220 is limited to be rotated in a single direction, thereby making it possible to effectively implement the color of the electronic paper display device.

Meanwhile, the cavity 218 may have all shapes such as an oval shape, an axial shape protruded toward the rotating ball, a polygonal shape, an atypical shape, and the like. That is, the shape of the cavity 218 may be variously changed, if it may limit the rotation of the rotating ball 220 in a single direction as described above.

As described above, an internal width of the cavity 218 is formed to be larger in the direction perpendicular to the coupled surface of the first hemisphere 222 and the second hemisphere 224 than that in the direction of the coupled surface of the first hemisphere 222 and the second hemisphere 224, thereby making it possible to minimize the friction force, when the rotating ball 220 is rotated in the direction perpendicular to the coupled surface of the first hemisphere 222 and the second hemisphere 224. Accordingly, when the electric field is applied to the rotating ball 220, it may induce the rotating ball 220 to be rotated in the direction perpendicular to the coupled surface of the first hemisphere 222 and the second hemisphere 224. In this case, the rotation of the rotating ball 220 is easily controlled as well as any one of a plurality of colors of the rotating ball 220 is clearly operated, thereby making it possible to improve a color contrast ratio of the display device.

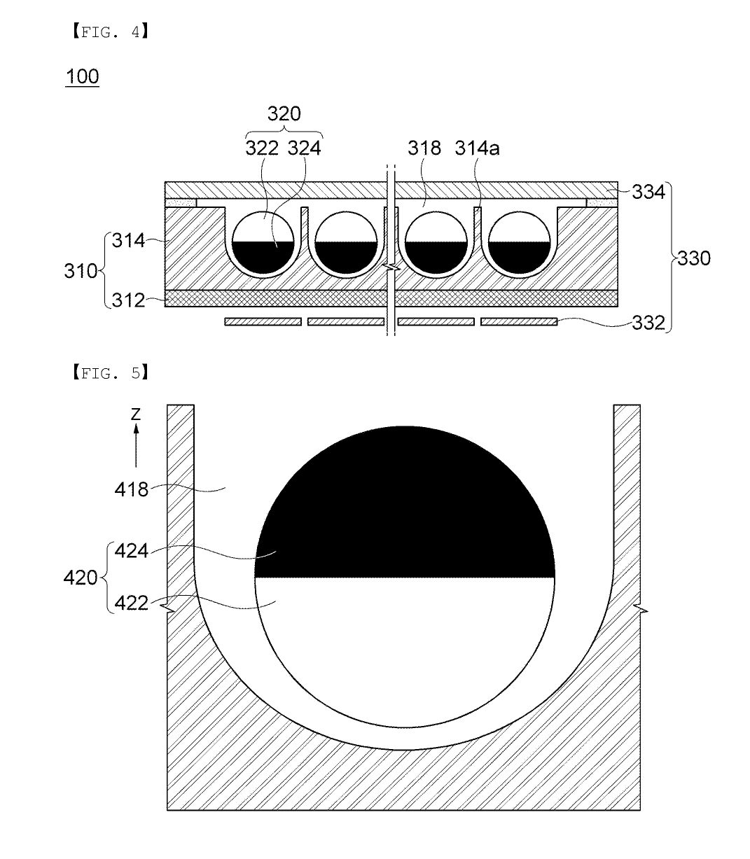

FIG. 3 is a cross-sectional view taken along line I-I′ of FIG. 1, and FIG. 4 is a cross-sectional view taken along line II-II′ of FIG. 1.

Referring to FIGS. 3 and 4, an electronic paper display device 100 according to an embodiment of the present invention may include a barrier rib structure 310, rotating balls 320, and an electrode structure 330. The barrier rib structure 310 includes a base substrate 312 and a partitioning barrier rib 314 disposed on the base substrate 312. The barrier rib substrate 310 supports the rotating balls 320, and partitions cavities 318 provided with the rotating balls 320. The base substrate 312 may be a supporting plate for forming and supporting the partitioning barrier rib 314. The base substrate 312 may be a plate made of at least any one of polyethylene terephthalate (TET), polycarbonate (PC), polyethersulphone (PES), and polyimide (PI). In addition, the base substrate 312 may be a metal plate made of a metal material such as copper (Cu). When the base substrate 312 is the metal plate, the base substrate 312 may be used as a lower electrode for driving the rotating balls 320.

Meanwhile, the partitioning barrier rib 314 has grooves defined as the cavities 318, and each of the cavities 318 is arranged with the rotating ball 320. The cavity 318 may be filled with a transparent insulating oil providing lubrication to the rotating balls 320 to easily rotate the rotating balls.

The partitioning barrier rib 314 may be configured to increase the number of the rotating balls 320 per unit area. For example, the partitioning barrier rib 314 may have a sidewall 314a with a vertical structure. At this time, as the thickness of the sidewall 314a is thinner, an interval between the cavities 318 is reduced, thereby making it possible to increase the number of the rotating balls 320 included in the partitioning barrier rib 314.

The electrode structure 330 may include a lower electrode 332 that is disposed under the barrier rib structure 310 and an upper electrode 334 that is disposed over the barrier rib structure 310. In addition, the electric field is formed between the upper electrode 334 and the lower electrode 332 to selectively rotate the rotating balls 320. Accordingly, the first hemisphere 322 and the second hemisphere 324 selectively face outwardly (upwardly in FIG. 3), thereby making it possible to implement a desired image. Meanwhile, a direction in which the electric field is applied from the barrier rib structure 310 to the rotating ball 320 may be a direction perpendicular to a surface on which the cavities 318 are arranged in a matrix shape.

Meanwhile, the barrier rib structure 310 may be formed by any one of a photolithography process, an imprint method, a dry etching method, and a wet etching method. When the photolithography process is used, the barrier rib structure 310 may be made of a photoreactive barrier rib material. For example, the barrier rib structure 310 may include an insulating resin, a hardener or a photoreactive material. Meanwhile, when the imprint method is used, after forming a resin layer on the substrate, partitioning spaces for disposing the rotating balls are formed in the resin layer using a stamp.

FIG. 5 is an enlarged view of one of cavities of FIG. 3. A cavity 418 partitioned by barrier ribs and a rotating ball 420 provided in the cavity 418 and rotated by an electric filed to implement a predetermined color are shown in FIG. 5. Herein, the rotating ball 420 may have a shape in which a first hemisphere 422 and a second hemisphere 424 are coupled to each other.

An electric field is applied, in a Z direction, to the rotating ball 420 of the cavity 418 shown in FIG. 5. Herein, the Z direction may a direction perpendicular to both of the X and Y directions shown in FIG. 2 and substantially perpendicular to a surface on which the cavities 418 are arranged.

A lower surface of the cavity 418 may be inclined toward a center thereof. A position of the rotating balls 420 in each of the cavities 418 is changed due to external impact or vibration during rotation of the rotating balls, such that a portion or all of the images implemented by the rotating balls 420 may be distorted. Accordingly, the lower surface of the cavity 418 is inclined, thereby making it possible to maintain the rotating ball 420 in the center of the cavity 418 despite the external impact or the vibration during the rotation of the rotating balls. In this case, the rotating balls 420 may be maintained in an aligned state, thereby making it possible to prevent the distortion of the image of the electrical paper display device. Although the lower surface of the cavity 418 may be formed in a smooth curved shape, it may also be formed in a polygonal shape.

As described above, the electronic paper display device 100 according to the exemplary embodiments of the present invention forms the cavity in an asymmetrical shape to make the friction force between the rotating ball and the inner surface of the cavity different according to the rotating direction of the rotating ball rotated within the cavity, thereby inducing the rotating ball to be rotated in a direction in which friction force is minimum. At this time, the rotating ball is induced to be rotated in the direction perpendicular to the coupled surface of the hemispheres. Therefore, the electronic paper display device easily controls the rotation of the rotating ball to selectively and easily implement mono-color the rotating ball, thereby making it possible to easily implement the color of the image.

The exemplary embodiments of the present invention forms the cavity in an asymmetrical shape to induce the rotating ball to be rotated in one direction, thereby making it possible to easily control the rotating ball.

The exemplary embodiments of the present invention induces the rotating ball to be rotated in the direction perpendicular to the coupled surface of the hemispheres, such that only one color is selectively displayed from the rotating ball having a plurality of colors, thereby making it possible to easily implement the color of the image

The exemplary embodiments of the present invention forms the lower surface of the cavity to be inclined, thereby making it possible to maintain the position of the rotating ball within the cavity despite the external impact or the vibration during the rotation of the rotating ball.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. An electronic paper display device, comprising:
a barrier rib structure providing a plurality of partitioning spaces; and
a plurality of rotating balls each disposed within the partitioning spaces in a form in which a first hemisphere and a second hemisphere are coupled,
wherein the rotating ball is rotated in a preset direction by a shape of the partitioning space.

2. The electronic paper display device according to claim 1, wherein a width in a first direction and a width in a second direction of the partitioning space are different from each other, the second direction being perpendicular to the first direction.

3. The electronic paper display device according to claim 2, wherein a friction force between the rotating ball and the inner surface of the partitioning space is larger in the first direction than in the second direction.

4. The electronic paper display device according to claim 2, wherein the width in a second direction of the partitioning space is larger than the width in a first direction thereof.

5. The electronic paper display device according to claim 2, wherein the ratio of the width in a first direction and the width in a second direction of the partitioning space is adjusted to be 0.6 or more to 0.9 or less.

6. The electronic paper display device according to claim 2, wherein the width in a first direction and the width in a second direction of the partitioning space is equal to or larger than a diameter of the rolling ball.

7. The electronic paper display device according to claim 2, wherein the first direction of the partitioning space is a direction of a coupled surface of the first and second hemispheres, and the second direction thereof is a direction perpendicular to the coupled surface of the first and second hemispheres.

8. The electronic paper display device according to claim 1, wherein a lower surface of the partitioning space is inclined toward a center thereof.

9. The electronic paper display device according to claim 8, wherein the lower surface of the partitioning space has a curved shape or a polygonal shape.

10. The electronic paper display device according to claim 1, wherein the first and second hemispheres have different colors.

11. An electronic paper display device, comprising:
a barrier rib structure providing a plurality of partitioning spaces partitioned by barrier ribs; and
a plurality of rotating balls formed by coupling a first hemisphere to a second hemisphere,
wherein an interval between the rotating ball and the inner surface of the partitioning space is larger in a second direction than in a first direction, the second direction being different from the first direction.

12. The electronic paper display device according to claim 11, wherein a width in a first direction and a width in a second direction of the partitioning space are different from each other.

13. The electronic paper display device according to claim 11, wherein the ratio of the width in a first direction and the width in a second direction of the partitioning space is 0.6 or more to 0.9 or less.

14. The electronic paper display device according to claim 11, wherein the width in a first direction and the width in a second direction of the partitioning space is equal to or larger than a diameter of the rolling ball.

15. The electronic paper display device according to claim 11, wherein the first direction is a direction of a coupled surface of the first and second hemispheres, and the second direction is a direction perpendicular to the coupled surface of the first and second hemispheres.

16. The electronic paper display device according to claim 11, wherein a lower surface of the partitioning space is inclined toward a center thereof.

17. The electronic paper display device according to claim 16, wherein the lower surface of the partitioning space has a curved shape or a polygonal shape.

18. The electronic paper display device according to claim 11, wherein the first and second hemispheres have different colors.
